(19) United States
(12) Patent Application Publication
(10) Pub. No.: US 2010/0152137 A1
(43) Pub. Date: Jun. 17, 2010

(54) Alkylphospholipids as active agents for prevention of plant pathogens

(75) Inventors: Hanns-Heinz Kassemeyer, Freiburg (DE); Ulrich Massing, Merzhausen (DE)

Correspondence Address: Ballard Spahr LLP, SUITE 1000, 999 PEACHTREE STREET, ATLANTA, GA, 30309-3915, US

(73) Assignee: KTB-Tumorforschungs GMBH, Freiburg (DE)

(21) Appl. No.: 12/308,621

(22) PCT Filed: Jun. 21, 2007
(86) PCT No.: PCT/EP2007/056218

§ 371 Date: Dec. 2, 2009

(30) Foreign Application Priority Data
Jun. 21, 2006 (EP) 06115845.7

(51) Int. Cl. A01N 57/12; C07F 9/06; A01P 15/00; A01P 3/00

(52) U.S. Cl. 514/77; 562/11

(57) ABSTRACT

The invention relates to a process for controlling plant pathogens comprising the application of alkylphospholipids as active substances. Further, the invention relates to the use of alkylphospholipids for controlling plant pathogens, and to an agent for controlling plant pathogens containing an effective amount of at least one alkylphospholipid.

The invention relates to a process for controlling plant pathogens comprising the application of alkylphospholipids as active substances. Further, the invention relates to the use of alkylphospholipids for controlling plant pathogens, and to an agent for controlling plant pathogens containing an effective amount of at least one alkylphospholipid.

### BACKGROUND OF THE INVENTION

Plants are infested by numerous pathogens, which in crops lead to yield losses and quality losses of the harvested material. The loss caused by pathogens on crops is about 20% of the harvest worldwide, which corresponds to a financial loss of more than 180 billion U.S. dollars. Lest the damage should become even higher, 2.5 million tons of plant protection agents are applied every year, which incurs costs of more than 25 billion U.S. dollars. In German viticulture alone, 175 tons of plant protection agents per year is employed for controlling the most important pathogen, grapevine downy mildew (Plasmopara viticola).

Downy mildew (Plasmopara viticola) belongs to the oomycetes and infests leaves and fruit of grapevine, which causes considerable damage. Since the parasite dwells almost its entire life cycle in the interior of the leaves, it is very difficult to control. Frequently, copper-containing preparations are employed, which is not only ecologically questionable, but also not quite effective. Apart therefrom, only phosphites are currently available to winemakers as active substances against P. viticola. However, phosphites have the disadvantage to be ecologically questionable.

Plant protection agents mostly have a very broad activity against a wide variety of pathogens, but also affect other organisms and may have a high negative impact on the ecosystem. Most plant protection agents contain synthetic active ingredients that often include heavy metals or in which chlorine is bound. These substances and their metabolites may easily get into the groundwater or become enriched in the soil. In addition, residues from plant protection agents on the harvest are undesirable for reasons of human toxicology. Therefore, the environmental and human toxicity of the preparations employed are a particular problem of plant protection today.

Most plant protection agents act directly on the pest organisms by interfering with essential life processes, such as primary metabolism. This is why their activity cannot be limited to a specific kind of organism; as a side effect of their use, the above mentioned impairment of other organisms of the ecosystem must be put up with.

An alternative approach for controlling plant pathogens is the utilization of the plants' natural resistance. All plants are capable of fighting pests by resistance reactions. Some of these pests, for example, grapevine downy mildew and powdery mildew, nevertheless succeed in overcoming these defense mechanisms. For grapevine, it is assumed that the resistance reactions are initiated too slowly to successfully suppress the pathogens. It is not always possible to breed crops having a sufficient permanent resistance by crossing with resistant species. However, resistance mechanisms can be induced throughout the plant by substances simulating an infection. This systemically induced resistance results in an enduring activity that is capable of fighting subsequent infections by pathogens.

Activation of the plant's own defense by treating the plants with molecules triggering a defense reaction opens further, basically new approaches in plant protection. This is another way of controlling plant pathogens without having to employ conventional plant protection agents.

On the other hand, the use of naturally occurring phospholipids (lysolipids and sphingolipids) and structurally analogous compounds as plant protection agents is known from the following documents: EP-A-0 050 460, EP-A-0 138 558, EP-A-0 138 559, WO 01/72130, U.S. Pat. No. 4,981,618, DD-A-222491 and DD-A-241187.

The compounds described in these documents are characterized by a structural similarity with naturally occurring phospholipids from lysolipids or sphingolipids and are very similar to the naturally occurring glycerophospholipids. Thus, they all have a C3 parent structure, which is either glycerol or 1,3-hydroxypropane. Now, the chemical structures necessary for the lipid character are bound through the alcohol functionalities. These may tend to be rather non-polar functionalities, which represent the corresponding non-polar moiety of the phospholipids, or they are polar functionalities, which represent the polar moiety of the amphiphilic lipids. The bonding of the non-polar functionalities is through ether or ester linkages, as is the case with naturally occurring phospholipids. The activity in plant protection as described for these molecules seems to be strongly associated with the presence of structural elements of natural phospholipids, such as ether and ester linkages, and of the natural parent structure, i.e., glycerol and sphingosine. Therefore, it was only consequent that such an activity could also be demonstrated for natural lysophospholipids.

Natural phospholipids or phospholipids strongly oriented by the natural structure and having a lysophospholipid character have the disadvantage of having a very limited life span in aqueous solution, especially in biological systems (cell membranes). Phospholipid-degrading enzymes will cleave ester and ether linkages at the glycerol parent structure (e.g., phospholipases A1 and A2, phospholipase C) and in sphingomyelins (sphingomyelinase, ceramidase). The phospholipids applied for plant protection quickly become part of the phospholipid membrane turnover occurring in living cells. In summary, this has the disadvantage that phospholipids as described in the above documents can show only a limited (low and/or short) effect. Of course, this especially affects quickly growing plants, such as seedlings and young plants and crops in general, which were bred for a rapid growth.

It is the object of the present invention to provide novel active substances for plant pathogen control which are safe in terms of human and environmental toxicology and do not contain any chlorine or heavy metals, in particular. In addition, the active substances according to the invention are to reach the plants easily (good bioavailability, simple application (solubility)), be prepared with high economical efficiency, have a long storage stability and be degradable in the plant and soil. These active substances should not have the above mentioned drawbacks of the sphingosine- or glycerol-based active substances, namely being degraded by phospholipid-degrading enzymes. In particular, an active substance for controlling downy mildew on grapevine is to be provided.

### SUMMARY OF THE INVENTION

Surprisingly, it has now been found that alkylphospholipids (APL) are particularly suitable as active substances for plant pathogen control that have no glycerol or sphingosine parent structure and in which the non-polar moiety of the molecule is directly linked to the polar phosphodiester. APLs, which were originally developed for tumor therapy, are not mutagenic, not teratogenic and not carcinogenic and are thus toxicologically safe. As compared to the lipid structures described to date for pathogen defense in plants, APLs have the advantage to be more metabolically stable. In particular, they do not have any “naturally occurring” structural elements of glycerophospholipids and sphingolipids, namely a central C3 parent structure or sphingosine. Structural elements of lipids connected through these central structures through ester, ether or amide linkages can be easily cleaved by the corresponding phospholipid-degrading enzymes.

This result was surprising also because to date, only those phospholipids having such central parent structures similar to those of the natural phospholipids have been described as effective in pathogen defense, and there were no indications that APLs, which do not have such parent structures, would have a comparable or even better activity.

Thus, the invention relates to:
(1) a process for controlling causative agents of plant diseases (plant pathogens), comprising the application of an effective amount of at least one alkylphospholipid or a salt thereof to the plants to be protected from plant diseases or infested with plant pathogens, to the habitat of the plants to be treated and/or to another area where the plant pathogens have occurred or might occur;
(2) the use of one or more alkylphospholipids or their salts for controlling causative agents of plant diseases; and
(3) an agent for controlling causative agents of plant diseases, containing an effective amount of at least one alkylphospholipid or a salt thereof.

### BRIEF DESCRIPTION OF THE FIGURES

The invention will be illustrated further by using the following Figures in the detailed description of the invention and the Examples.

FIG. 1: Intensity of infestation with downy mildew on leaf disks treated with 0.0001% (w/v), 0.001% (w/v), 0.01% (w/v) or 0.1% (w/v) hexadecylphosphocholine (HePC) (cf. Example 2). Negative control: distilled water; positive control: phosphite.

FIG. 2: Effect of HePC on the intensity of infestation by Plasmopara viticola on intact plants.

FIG. 3: Effect of HePC on the frequency of infestation by Plasmopara viticola on intact plants.

### DETAILED DESCRIPTION OF THE INVENTION

In the following, some of the terms employed are specified at first:

“Plant pathogens” or “plant-pathogenic organisms” are organisms that can infest plants and cause damage to the plants. In crops, such a damage results in losses of yield and quality. This may even end up in a complete loss of yield and in complete death of the infested plant. Plant-pathogenic organisms within the meaning of the present invention preferably include microorganisms, fungi, oomycetes, bacteria and viruses.

“Plant protection agents” are active substances and formulations designed to protect plants, living parts of plants or plant products from pest organisms including the above mentioned plant pathogens, or to prevent the action of pest organisms. Plant protection agents are usually so-called formulations, i.e., in addition to the actual active ingredient, they also contain additives that are to provide for a better distribution of the agent, for example. Plant protection agents according to the invention also include so-called plant strengthening agents, i.e., active substances and formulations designed to enhance the plants' resistance against pest organisms. The pest organisms that are to be controlled with the plant protection agents according to the invention preferably include microorganisms, fungi, oomycetes, bacteria and viruses. The plant protection agents may further contain one or more formulation aids.

An “active substance” within the meaning of the present invention is a compound that can cause a physiological response in plants or plant pathogens and thus protects a plant from infestation by the pathogen and/or from the disease caused by the pathogen. In the following and unless stated otherwise, the term “active substance or substances” designates the alkylphospholipids and their salts as used in the invention.

“Phospholipids” (also referred to as “PL” in the following) usually consist of a hydrophilic head connected through a negatively charged phosphate group to hydrophobic non-polar residues.

“Alkylphospholipids” (APL) within the meaning of the present invention are phospholipids having the structure

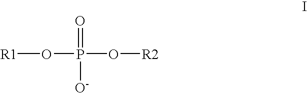

wherein R1 is selected from a C₈₋₂₄ hydrocarbon chain that is saturated or unsaturated, linear or branched. This chain may have one or more substituents that are independently selected from —OR5, —N(R6)ₘ or O—C(═O)—R7. R5 and R6 are independently selected from —H and C₁₋₆ alkyl, preferably from —H and C₁-C₂ alkyl, more preferably from —H and —CH₃. R7 is preferably a C₁₋₅ alkyl, more preferably methyl or ethyl, even more preferably methyl. m is either 2 or 3, preferably 2. The substituents are preferably bonded to carbon atoms in the vicinity of the phosphate group, more preferably to the second carbon atom of the hydrocarbon chain.

The residue R2 is a polar group, preferably a five- or six-membered ring containing N or O atoms, a C₁ to C₄ chain substituted with —N(R6)ₘ (as defined above) and/or —OH, a sugar alcohol or an amino acid. Preferably, it is selected from inositol, choline, ethanolamine, serine or nitrogen heterocycles, more preferably from choline or ethanolamine. Choline is even more preferred.

APL having chirality centers can be used in R or S configuration or as a racemate in the present invention.

The APLs employed in the present invention preferably contain a choline residue as R2 and are thus alkylphosphocholines (APCs).

It is further preferred that the APLs contain a C₈₋₂₄ hydrocarbon chain as R1, which is saturated or unsaturated, linear or branched. More preferably, this chain is linear and, in particular, it is additionally saturated, i.e., a C₈₋₂₄ alkyl. The chain length is preferably C₁₄₋₂₀, more preferably C₁₆₋₁₈, and even more preferably, R1 or R3 or R4 are hexadecyl (C₁₆) or octadecyl (C₁₈).

Even more preferably, APLs are selected from the group comprising hexadecylphosphocholine (HePC), octadecyl-(1,1-dimethyl-4-piperidylio)phosphate (Perifosin), erucylphosphocholine (ErPC), erucyl-(N,N,N-trimethyl)-propanolamine phosphate (ErPC3), and 1-O-phosphocholino-2-O-acyloctadecane (Massing, U. and Eibl, H., Chem. Phys. Lipids 69: 105-120 (1994)), and 1-O-phosphocholino-2-O-methyl-octadecane (WO 2006/024675). HePC is most preferred.

The process according to the invention serves for protecting plants from infestation by pathogens, preferably for protection from and control of plant diseases caused by viruses, bacteria, fungi and organisms resembling fungi (oomycetes). According to the invention, the alkylphospholipids are employed, in particular, for protecting crops from common diseases (Phytophthora on potatoes, scab on apples, powdery or downy mildew on ornamental plants (especially roses), grapevine and cereals and other economically important diseases on fruits, vegetables and cereals), mainly for protecting grapevine from downy mildew (Plasmopara viticola) and powdery mildew (Uncinula necator). They are environment-friendly and are mainly suitable for ecological agriculture due to their toxicological profile.

To date, APCs have been employed for therapeutic purposes, predominantly as antitumor agents (examples: hePC (miltefosin), perifosin, erucyl-PC3 etc.). Miltefosin has been approved as a skin ointment against skin metastases and as an oral medicament against leishmaniosis. Currently, a number of APLs are being clinically tested against tumor diseases (perifosin, erucyl-PC3). The mechanism of action on which the anti-tumor activity of the APCs is based probably involves induction of apoptosis in many tumor cells by activating the FAS receptor (CD95), and in part also an inhibition of phospholipid biosynthesis and phospholipid degradation. The mechanism of the anti-leishmaniosis activity is not known.

In one aspect of the invention, the above mentioned active substances, i.e., APLs and their salts, are characterized by being effective against plant-pathogenic fungi and oomycetes. Thus, they are suitable for controlling these plant pathogens. They can be employed, in particular, for controlling phytopathogenic fungi, such as plasmodiophoromycetes, oomycetes, chytridiomycetes, zygomycetes, ascomycetes, basidiomycetes and deuteromycetes. They are preferably used for controlling oomycetes, more preferably those of the order Peronosporales, even more preferably those of the family Peronosporaceae, especially the Plasmopara species, especially P. viticola.

In a further aspect of the invention, the above mentioned active substances are suitable for controlling bacteria. They can be employed, in particular, for controlling phytopathogenic bacteria, such as acetic acid bacteria (pathogens causing bunch rot).

The activity of the active substances according to the invention against fungi and oomycetes has the result that the most preferred use of the active substances is in controlling phytopathogenic fungi and fungal infestation on plants or plant parts (such as seeds), especially in controlling fungi and oomycetes, especially oomycetes of the order Peronosporales as well as powdery mildew and Botrytis cinerea. More preferred is the use for controlling oomycetes of the family Peronosporaceae, especially Plasmopara species, especially P. viticola.

In a further preferred aspect of the invention, the above mentioned active substances are systemically effective and can be employed as a leaf and soil plant protection agent. They are preferably leaf plant protection agents since of these, lesser amounts per treated area need be employed to achieve the desired effect.

The plant to be protected within the scope of the present invention is either already infested with the plant pathogen or is to be prevented from such infestation. It is preferably a crop such as cereals, rice, corn, soybean, lawn, cotton, coffee, sugar cane, grapevine, fruit and ornamental plants, vegetable crops. More preferably, the plant is a plant susceptible to powdery or downy mildew, especially a rose or grapevine. Even more preferably, the plant to be protected is a grapevine (Vitis vinifera).

In particular, the above mentioned active substances are suitable for controlling the following plant diseases on special plants: powdery mildew (Erysipe necator or Uncinula necator), downy mildew (Plasmopara viticola) and Botrytis (gray mold; Botrytis cinerea) on crops and ornamental plants, especially grapevine.

The process according to the invention includes the treatment of the plant pathogen, the plant to be protected and/or its habitat with the agent according to the invention containing alkylphospholipids and/or salts thereof. Further, seed stock, seeds, soils, areas, materials or spaces that are to be kept free from plant pathogens can be treated with the agent according to the invention. Treatment of aerial parts and of the soil is possible. The treatment of aerial parts is preferred. Also, a treatment is possible in all developmental stages of the plants including as a seedling, germ and shoot.

According to the invention, the above mentioned active substances are employed by treating the plant pathogens, the plants to be kept free therefrom and/or areas with an effective amount of the active substances. The application is effected before or after infestation with the pathogen, but preferably before infestation.

The application of the active substances or of the agent according to the invention is effected in the usual way, i.e., among others, by pouring, spattering, spraying, scattering, brushing, pickling or incrusting.

The agent according to embodiment (3) is a plant protection agent, preferably an agent for controlling plant pathogens, especially fungi, oomycetes, bacteria and/or viruses. It is a formulation that may contain one or more auxiliary agents, especially formulation agents, in addition to the actual active substance. As active substances for controlling plant pathogens, it preferably contains exclusively the active substances according to the invention.

The above mentioned active substances may be used in the formulations usually employed in plant protection, such as emulsions, solutions, suspensions, powders, granules, seed coatings. The preparation of such formulations is effected by usual methods, such as blending the active substance according to the invention with vehicles or solvents, optionally using formulation aids, such as emulsifiers or dispersing agents.

The agent according to the invention generally contains from 0.1 to 100% by weight of the above mentioned active substances, preferably from 0.5 to 90% by weight, more preferably from 1 to 10% by weight. As active substances, it preferably contains exclusively the above mentioned active substances. The agent may be applied as such, in form of the above mentioned formulations or the application forms prepared therefrom, such as ready-to-use solutions, and concentrates.

Before the active substances or formulations are applied, they may be processed into suitable application forms, especially by preparing ready-to-use solutions. The application forms depend on the intended use, the kind, place and circumstances of application. Advantageously, it should ensure the fine dispersion of the active substances according to the invention over the treated area. Normally, the plants are sprayed with the active substances.

The concentrations of the active substances in the ultimately applied application forms depend on the object to be treated. When aerial parts are treated with a solution, the compound has a concentration of at least 0.0001% (w/v), preferably at least 0.001% (w/v), more preferably 0.01% (w/v), in the solution applied. Its maximum concentration is preferably 1% (w/v).

Depending on the kind of effect desired, the application amounts are from 0.025 to 2 kg of active substance, preferably from 0.1 to 1 kg of active substance, per ha of treated area. When seeds are treated, amounts of active substance of from 0.001 to 50, preferably from 0.01 to 10 g, per kg of seeds are employed.

Even more preferably, the present invention relates to a process for controlling Plasmopara viticola on grapevine (Vitis vinifera) by applying an effective amount of HePC to the grapevines. In a test system with cell cultures of grapevine (Vitis vinifera cv. Pinot noir), it was established by the method of Felix, J. et al., Plant J. 4: 307-316 (1993), that alkylphospholipids can cause ion channels in the outer membrane of plant cells to open. This is an indication that APLs can induce the plant's own resistance reactions. In this case, APL or a formulation containing APL would be a plant strengthening agent.

In another test, an effect of alkylphospholipids on the pathogen causing grapevine downy mildew (Plasmopara viticola) was established. In this test, grapevine leaf disks were treated with different concentrations of the test substances and subsequently inoculated with a defined amount of spores from Plasmopara viticola. The outbreak of sporangia, which is the third stage of a grapevine downy mildew disease after infection and incubation time, was observed. The evaluation showed that APLs can protect grapevine from P. viticola infestation. The results allow to conclude that alkylphospholipids and the lysophospholipids, which are structurally very similar to the APLs, either activate the plant's resistance or have a direct effect on the pathogen, for example, cause damage to the pathogen membrane.

The invention will be illustrated further by means of the following Examples, which do not, however, limit the invention.

### EXAMPLES

In the following Examples, methods usual in plant-biochemical laboratories were employed, among others for the growing and maintenance of plants, plant cell cultures and callus cultures, and for the preparation of the yeast extract used as a reference.

### Example 1

### Examination of Potential Resistance Induction in Single Cell Cultures of Grapevine

A response of plant cells to substances that can induce resistance in plants is to open ion channels in the cell membrane. Thereupon, protons flow into the interior of the cell, which causes alcalinization of the medium surrounding the cell. This temporary alcalinization has been measured.

Greenhouse plants of the variety Pinot noir (Vitis vinifera cv. Pinot noir) served as the starting material. A callus culture was started first from young shoots. Thus, the plant parts were cut into pieces about 1-2 cm in size, washed in 70% (v/v) ethanol and sterilized in 3.5% (w/v) NaOCl solution for about 2 min. The sterilized tissue pieces were transferred to solid MS nutrient medium (Murashige, T. and Skoog, F., Physiol. Plant, 18: 100-127 (1962)) and slightly pushed into the agar, so that the cuts came into contact with the medium. The formation of callus tissue occurred at 23° C. in a phytochamber (16 h of white light 300 μmol m⁻² s⁻¹; 8 h of dark; >95% relative humidity). At the cuts, calluses formed, which were repeatedly transferred to a new medium in a sterile manner after 4-6 weeks.

Starting from strongly growing callus cultures, single cell cultures were started. Thus, cells were passaged under sterile conditions from callus tissue to liquid MS nutrient medium. The cell cultures were grown in a temperature constant room at 23° C. on a rotary shaker (120 rpm). In regular passage cycles of 4 days, the cell cultures were admixed with 40 ml of new liquid MS nutrient medium and distributed in two equal parts of about 40 ml to two 250 ml Erlenmeyer flasks.

For measuring the pH of the medium, 10 ml of a 2 days old cell culture was added to a small rolled rim vial. The rolled rim vial was placed onto a shaker, and a pH electrode was immersed into the cell culture. The electrode was fixed to be constantly washed round by the cell culture. The revolutions per minute of the shaker was 140 rpm. After the measured pH had stabilized, the substance to be tested was added, and the change of pH was continuously recorded with a plotter.

The results for hexadecylphosphocholine are shown in Table 1:

TABLE 1
pH change in the medium of a single cell
culture of Vitis vinifera cv. Pinotnoir
after addition of hexadecylphosphocholine (HePC)

| | Δ (pH) |
|---|---|
| HePC final concentration | |
| 0.00100% (w/v) | 0.41 |
| 0.00075% | 0.25 |
| 0.00050% | 0.16 |
| 0.00025% | 0.03 |
| 0.00000% | 0 |
| Positive control (yeast extract) | |
| 0.0001% (1 μg/ml) | 0.21 |

An increase of the pH of the medium, i.e., an alcalinization, can be observed as the HePC concentrations increase.

### Example 2

### Test of HePC for Controlling the Pathogen causing Downy Mildew of Grapevine

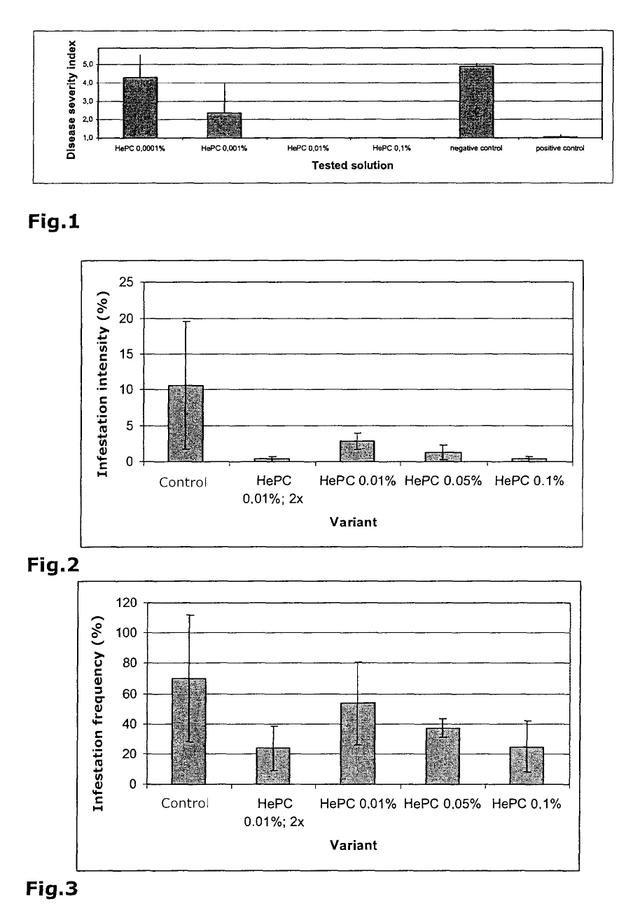

Greenhouse plants of the variety Müller-Thurgau (Vitis vinifera cv. Müller-Thurgau) served as the starting material. Young leaves were sterilized on the surface with 70% (v/v) ethanol. Subsequently, leaf disks of 16 mm in diameter were punched out and placed upside down onto water agar (0.8%) in transparent boxes. One drop (about 60 μl) of an aqueous test solution (concentrations employed, see FIG. 1) was applied 24 h before the infection with the pathogen causing downy mildew (Plasmopara viticola), and the leaf disks were incubated at 25° C. (16 h of white light 300 μmol m⁻² s⁻¹; 8 h of dark) and >95% relative humidity. After 24 h, the drop was removed and replaced by a drop containing spores of the pathogen (about 50 μl of an aqueous suspension containing 2×10⁵ sporangia/mil). The infestation intensity was determined six days after the infection.

The infestation intensity was determined by means of a five-point scale ranging from 1 (no sporulation) to 5 (sporulation all over the surface). For each substance and concentration, 10 leaf disks per experiment were evaluated, and the mean value from at least three independent parallel experiments was determined. Distilled water and phosphite as negative and positive controls, respectively. The results for HePC are shown in FIG. 1. The individual results are shown in table 2:

TABLE 2

| | No. of | | | | | | Average |
|---|---|---|---|---|---|---|---|
| | leaf | | | | | | infestation |
| Test compound | disks | 1 | 2 | 3 | 4 | 5 | intensity |
| HePC 0.0001% | 9 | 0 | 0 | 0 | 0 | 9 | 5.0 |
| HePC 0.0001% | 9 | 0 | 2 | 6 | 1 | 0 | 2.9 |
| HePC 0.0001% | 9 | 0 | 0 | 0 | 0 | 9 | 5.0 |
| HePC 0.001% | 9 | 0 | 1 | 3 | 4 | 1 | 3.6 |
| HePC 0.001% | 9 | 9 | 0 | 0 | 0 | 0 | 1.0 |
| HePC 0.001% | 9 | 0 | 1 | 2 | 3 | 3 | 3.9 |
| HePC 0.001% | 9 | 9 | 0 | 0 | 0 | 0 | 1.0 |
| HePC 0.01% | 9 | 9 | 0 | 0 | 0 | 0 | 1.0 |
| HePC 0.01% | 9 | 9 | 0 | 0 | 0 | 0 | 1.0 |
| HePC 0.01% | 9 | 9 | 0 | 0 | 0 | 0 | 1.0 |
| HePC 0.01% | 9 | 9 | 0 | 0 | 0 | 0 | 1.0 |
| HePC 0.01% | 9 | 9 | 0 | 0 | 0 | 0 | 1.0 |
| HePC 0.01% | 9 | 9 | 0 | 0 | 0 | 0 | 1.0 |
| HePC 0.1% | 9 | 9 | 0 | 0 | 0 | 0 | 1.0 |
| HePC 0.1% | 9 | 9 | 0 | 0 | 0 | 0 | 1.0 |
| HePC 0.1% | 9 | 9 | 0 | 0 | 0 | 0 | 1.0 |
| HePC 0.1% | 9 | 9 | 0 | 0 | 0 | 0 | 1.0 |
| HePC 0.1% | 9 | 9 | 0 | 0 | 0 | 0 | 1.0 |
| HePC 0.1% | 9 | 9 | 0 | 0 | 0 | 0 | 1.0 |
| neg. control (water) | 9 | 0 | 0 | 0 | 0 | 9 | 5.0 |
| neg. control (water) | 17 | 0 | 0 | 2 | 1 | 14 | 4.7 |
| neg. control (water) | 27 | 0 | 0 | 0 | 1 | 26 | 5.0 |
| pos. control (Lebosol 0.2%) | 26 | 26 | 0 | 0 | 0 | 0 | 1.0 |
| pos. control (Lebosol 0.2%) | 9 | 8 | 0 | 1 | 0 | 0 | 1.2 |
| pos. control (Lebosol 0.2%) | 9 | 9 | 0 | 0 | 0 | 0 | 1.0 |
| pos. control (Lebosol 0.2%) | 8 | 8 | 0 | 0 | 0 | 0 | 1.0 |

Lebosol contains 24.2% P₂O₅. Lebosol 0.2% contains 0.2% Lebosol and thus about 0.05% phosphite.

Therefrom, the following average values for the infestation intensity are obtained:

| | |
|---|---|
| HePC 0.0001% | 4.3 |
| HePC 0.0001% | 2.4 |
| HePC 0.0001% | 1.0 |
| HePC 0.0001% | 1.0 |
| negative control | 4.9 |
| positive control | 1.1 |

An infestation intensity of less than 2.5 indicates a good defense against P. viticola.

### Example 3

### Test of HePC for Controlling the Pathogen causing Downy Mildew of Grapevine on Intact Plants

Greenhouse plants of the variety Müller-Thurgau (Vitis vinifera cv. Müller-Thurgau) served as the starting material. At least three plants each in the ten leaf stage were employed per test solution. HePC was applied (sprayed with the application device System Schachtner) in concentrations of 0.01%, 0.05% and 0.1%. In an additional experiment with 0.01% HePC, the same concentration of HePC (0.01%) was additionally applied one week before (2×HePC). After 24 h from the application of the test solutions, the plants were infected with the pathogen causing downy mildew (Plasmopara viticola). Six days after the infection, the sporulation of Plasmopara viticola was induced, and then the infestation intensity was established.

Thus, the percent proportion of the sporulating surface area relative to the entire surface area of each leaf was visually observed. For each substance and concentration, the leaves of at least three plants were evaluated, and the mean value determined. The application of distilled water served as a negative control. The experiment was repeated twice. The results are shown in FIGS. 2 and 3. The individual results are shown in Table 3.

Both the intensity and the frequency of infestation with Plasmopara viticola is highly reduced by the application of HePC (FIGS. 2 and 3 and Table 3). The effect (stated as a relation value II (RV II in Table 3) of HePC on the infestation intensity is very strong in dosages of 0.05% and 0.1% (RW II=87.8% and 96.6%, respectively), and also for two applications of 0.01% HePC (RW II=96.5%). Applied once, a low concentration of HePC (0.01%) shows a weaker effect on infestation with Plasmopara viticola (RW II=73.2%).

HePC also reduces the infestation frequency strongly in dosages of 0.1% (RW II=64.2%) and for two applications of 0.01% HePC(RW II=66.1%), and more weakly in lower concentrations, 0.05% (RW II=47.0%) and 0.01% (RW=23.6%).

TABLE 3

| | | II | IF | | | | | | | | | | |
|---|---|---|---|---|---|---|---|---|---|---|---|---|---|
| | | (%) | (%) | II (%) | IF (%) | min. | max. | min. | max. | | | | |
| | | per | per | per | per | value II | value II | value IF | value IF | Variance | Variance | RW II | RW II |
| Variant | REP | REP | REP | variant | variant | (%) | (%) | (%) | (%) | II | IF | II (%) | IF (%) |
| Var. 1 | A | 10.83 | 100.0 | 10.63 | 69.9 | 1.67 | 19.38 | 22.2 | 100.00 | 8.86 | 41.77 | | |
| Control | B | 19.38 | 87.5 | | | | | | | | | | |
| | C | 1.67 | 22.2 | | | | | | | | | | |
| | D | 29.09 | 100.0 | | | | | | | | | | |
| | E | 24.09 | 100.0 | | | | | | | | | | |
| | F | 25.91 | 90.9 | | | | | | | | | | |
| Var. 2 | A | 0.20 | 20.0 | 0.37 | 23.7 | 0.11 | 0.80 | 11.1 | 40.0 | 0.37 | 14.80 | 96.51 | 66.09 |
| HePC | B | 0.80 | 40.0 | | | | | | | | | | |
| 0.01%; 2 x | C | 0.11 | 11.1 | | | | | | | | | | |
| | D | | | | | | | | | | | | |
| Var. 3 | A | 1.67 | 22.2 | 2.85 | 53.4 | 1.67 | 4.00 | 22.2 | 71.4 | 1.17 | 27.14 | 73.16 | 23.56 |
| HePC 0.01% | B | 2.89 | 66.7 | | | | | | | | | | |
| | C | 4.00 | 71.4 | | | | | | | | | | |
| Var. 4 | A | 2.22 | 33.3 | 1.30 | 37.0 | 0.33 | 2.22 | 33.3 | 44.4 | 0.94 | 6.42 | 87.80 | 47.02 |
| HePC 0.05% | B | 1.33 | 44.4 | | | | | | | | | | |
| | C | 0.33 | 33.3 | | | | | | | | | | |
| | D | | | | | | | | | | | | |
| Var. 5 | A | 0.11 | 11.1 | 0.36 | 25.0 | 0.11 | 0.89 | 11.1 | 44.4 | 0.37 | 16.67 | 96.60 | 64.24 |
| HePC 0.1% | B | 0.33 | 33.3 | | | | | | | | | | |
| | C | 0.89 | 44.4 | | | | | | | | | | |
| | D | 0.11 | 11.1 | | | | | | | | | | |

### Example 4

### Test of HePC for Controlling the Pathogen causing Downy Mildew of Grapevine on Intact Plants (Seedlings)

The examinations were performed with seedlings of the variant “Gutedel”, the seedlings having 3-4 leaves and a height of 8-12 cm at the time of application. HePC (0.01 and 0.001%) was applied with a rotary plate automated spraying device (about 1.2 bar spraying pressure) for 20 seconds. For each concentration, 6 plants were treated, which also applied to the positive control (infection, no treatment) and negative control (no infection, no treatment).

After the leaves had dried, the plants were infected/sprayed with Plasmopara viticola (spore suspension (100,000 spores/ml)) and further kept at 21° C. and 100% RH in a cycle of 16 h of day and 8 h of night.

The result of this infection experiment was evaluated after 10 days, the plants had a height of 10-14 cm and 4-5 leaves. The proportion of leaves infested (incidence) and the intensity of infestation, i.e., the infested proportion of the leaf areas, were evaluated. The results are shown in Table 4.

Infection control is rather successful with 0.01% HePC (infestation density: 3.6%; pos. control: 55.3%). At a 10 times lower concentration (0.001% HePC), the infestation is increased by a factor of 10 as well. Thus, a linear dose-effect relationship is found at least for the range of 0.01-0.001%.

The effect of HePC on the influence on infestation incidence could also be shown. Thus, with HePC 0.01%, only 25% of the leaves is infested as compared to the positive control.

TABLE 4
Prevention by HePC of pathogen infestation
(Plasmopara viticola) of Gutedel seedlings

| | | Infestation | | Infestation | Std. |
|---|---|---|---|---|---|
| Treatment | N | incidence (%) | Std. dev. | intensity (%) | dev. |
| neg. control | 6 | 0 | 0 | 0 | 0 |
| pos. control | 6 | 51 | 14 | 55.3 | 6.7 |
| HePC 0.01% | 6 | 13 | 12 | 3.6 | 2.9 |
| HePC 0.001% | 6 | 43 | 18 | 33.9 | 14.6 |

### Example 5

### Test of HePC for Controlling the Pathogen causing Downy Mildew of Grapevine on Intact Plants (Outdoor Test in the Vineyard under Practical Conditions)

Currently (vegetation period of 2007), HePC (0.2%) is being tested in an outdoor test. In these experiments, the plants in a commercial vineyard (Müller-Thurgau, age about 15 years) are not artificially infected. For this experiment, 3×6 plants (different locations in the vineyard) were employed. In addition, a corresponding untreated control is observed. By the end of June (Jun. 19, 2007), despite of the fact that the vegetation period was not yet completed, it was found that HePC shows a good effect in the prevention of pathogen infestation. Thus, to date, it has not been possible to observe infestation of the plants treated with HePC, despite of the currently sticky and humid weather (optimum infection conditions) and the very early start of the vegetation period in this year. In contrast, infestation of the control has already been observed.

1-12. (canceled)

13. A process for controlling causative agents of plant diseases (plant pathogens) in crops, comprising the application of an effective amount of at least one alkylphospholipid having the structure 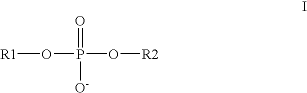
wherein R1 is selected from the group consisting of a C₈₋₂₄ hydrocarbon chain that is saturated or unsaturated, linear or branched and may optionally have one or more substituents selected from —ORS, —N(R6)ₘ and O—C(═O)—R7;
R2 is a polar group selected from the group consisting of a five- or six-membered ring containing N or O atoms, a C₁ to C₄ hydrocarbon chain substituted with —N(R6), and/or —OH, a sugar alcohol and an amino acid;
R5 and R6 are independently selected from the group consisting of —H and C₁₋₆ alkyl;
R7 is a C₁₋₅ alkyl; and
m is an integer selected from the group consisting of 2 and 3;
or a salt thereof to the crops to be protected from plant diseases or infested with plant pathogens, to the habitat of the crops to be treated and/or to another area where the plant pathogens have occurred or might occur.

14. The process according to claim 13, wherein said crop is a grapevine.

15. The process according to claim 13, wherein R2 in said alkylphospholipid is selected from the group consisting of inositol, choline, ethanolamine, serine and nitrogen heterocycles.

16. The process according to claim 15, wherein R2 is selected from the group consisting of choline and ethanolamine.

17. The process according to claim 15, wherein said alkylphospholipid is an alkylphosphocholine or a salt thereof.

18. The process according to claim 15, wherein said alkylphospholipid contains a saturated C₁₆₋₂₄ hydrocarbon chain as an alkyl residue.

19. The process of claim 18, wherein said Alkylphospholipid is hexadecylphosphocholine (HePC).

20. The process according to claim 13, wherein said plant pathogen is selected from the group consisting of microorganisms, viruses, oomycetes, fungi and bacteria.

21. The process according to claim 20, wherein said plant pathogen is selected from the group consisting of fungi and oomycetes.

22. The process of claim 20, wherein the pathogen is a pathogen causing powdery or downy mildew.

23. The process according to claim 14, wherein said plant is Vitis vinifera, said plant pathogen is Plasmopara viticola, and said compound is hexadecylphosphocholine.

24. The process according to claim 13, wherein said application is effected by spraying, inserting into the soil, application by watering, treatment of the plant's surface, preferably by spraying or treatment of the plant's surface.

25. The process according to claim 24, wherein said application is effected by spraying.

26. The process according to claim 24, wherein from 0.025 to 2 kg/ha of the compound is applied.

27. The process according to claim 24, wherein said application is effected before infestation with the plant pathogen occurs.

28. The process according to claim 24, wherein said alkylphospholipids and the salts thereof have a concentration in the applied solution of at least 0.0001% (w/v).

29. The process according to claim 28, wherein said alkylphospholipids and the salts thereof have a concentration in the applied solution of at least 0.001% (w/v).

30. An agent for controlling causative agents of plant diseases, containing an effective amount of at least one alkylphospholipid or a salt thereof as defined in claim 13.

31. The agent according to claim 30, which is an agent for controlling fungi, oomycetes, viruses and/or bacteria and/or contains at least one formulation aid.
